(19) United States
(12) Patent Application Publication
(10) Pub. No.: US 2004/0064609 A1
(43) Pub. Date: Apr. 1, 2004

(54) Host interface, device interface, interface system, and computer program product

(76) Inventors: Norio Sanma, Okazaki-city (JP); Naohiro Sakashita, Obu-city (JP)

Correspondence Address: POSZ & BETHARDS, PLC, 11250 ROGER BACON DRIVE, SUITE 10, RESTON, VA, 20190, US

(21) Appl. No.: 10/648,358

(22) Filed: Aug. 27, 2003

(30) Foreign Application Priority Data
Aug. 29, 2002 (JP) 2002-251471

(51) Int. Cl. G06F 13/12

(52) U.S. Cl. 710/64; 710/65

(57) ABSTRACT

An interface system includes a host interface and a device interface. Both interfaces are provided between a DVD drive and a MPEG2 decoder, which have an ATAPI protocol interface. When the host interface receives ATAPI protocol data from the MPEG2 decoder, it converts the ATAPI protocol data to high speed LAN protocol data, and transmits the converted data to the device interface. When the device interface receives converted data, it converts them to the ATAPI protocol data, and transmits the ATAPI protocol data to the DVD drive.

### CROSS REFERENCE TO RELATED APPLICATIONS

This application is based on Japanese Patent Application No. 2002-251471 filed on Aug. 29, 2002, the contents of which are incorporated herein by reference.

### BACKGROUND OF THE INVENTION

1. FIELD OF THE INVENTION

The present invention relates to a host interface, a device interface, an interface system, and a computer program product, more particularly to connective devices that have an interface for an advanced technology attachment (ATA) or an interface for an advanced technology attachment packet interface (ATAPI).

2. DESCRIPTION OF RELATED ART

Vehicular navigation system has a Compact Disc Read Only Memory (CD-ROM) or a Digital Versatile Disc Read Only Memory (DVD-ROM) as data storage for map data. A main unit of the vehicular navigation system is connected to a CD-ROM drive or a DVD-ROM drive via an ATAPI interface, which is standardized by the American National Standards Institute (ANSI).

According to the standard for the ATAPI, devices such as the CD-ROM and the DVD-ROM have to be connected to a host device such as the main unit of the vehicular navigation system with a cable within 0.46 meter. Accordingly, it is necessary to fully take into consideration about installation positions of the devices. It is same if a hard disk drive (HDD) is used as the storage because an ATA interface, which is used for the HDD, has a limitation same as the ATAPI interface.

In such a vehicular navigation system, the main unit of the vehicular navigation system is placed close to the CD-ROM drive or the DVD-ROM drive, and it is separated from a display of the vehicular navigation system, so that the display is connected via cables. As a result, a lot of long cables are necessary to transmit image signals, such as an RGB, a Vertical Synchronizing signal (Vsync), a Horizontal Synchronizing signal (Hsync), and a DotClock, from the main unit to the display. This increases the number of cables in the vehicle, and degrades image quality because of wiring conditions of the cables.

In addition, it is desired that the CD-ROM drive and the DVD-drive should be placed at separated position such as a trunk because they are comparatively large equipment compared with other equipments.

### SUMMARY OF THE INVENTION

An object of the present invention is to provide a host interface, a device interface, an interface system, and a computer program product to extend a connectable distance between a host and a device having an ATA/ATAPI interface, and to improve flexibility of arrangements of the host and the device.

According to one aspect of the present invention, a host interface has a first interface and a second interface. The first interface communicates a first data defined by a first protocol with a first device. For example, the first protocol is an ATA or an ATAPI, and the first device is a host device. The second interface communicates a second data defined by a second protocol with a second device.

When the first interface receives the first data defined by the first protocol from the first device, the first data is converted to the second data defined by the second protocol. The converted second data is transmitted to the second interface. Then, the converted second data is transmitted to the second device through the use of the second protocol.

On the other hand, when the second interface receives the second data defined by the second protocol from the second device, the second data is converted to the first data defined by the first protocol. The converted first data is transmitted to the first interface. Then, the converted first data is transmitted to the first interface through the use of the first protocol. In addition, the converted first data is stored in the memory.

Then, unless the second interface receives subsequent second data, the controller transmits the converted first data stored in the memory to the first interface in response to a request of the first device in order to transmit the data to the first device.

According to another aspect of the present invention, an interface system has a host interface and a device interface. The host interface communicates a first data defined by a first protocol with a first device, and it communicates second data defined by a second protocol with the device interface. The device interface communicates the first data defined by the first protocol with a second device, and communicates the second data defined by the second protocol with the host interface.

If the system uses the second protocol that allows a long connectable distance more than the first protocol, a connectable distance between the first device and the second device can be extended. In addition, if the host interface does not receive further data by the time that the host interface receives a request from the first device, the host interface can pretend that the host interface receives correctly from the second device (device interface) because stored data in the memory is transmitted to the first interface instead. Accordingly, a delay time of communication between the first device and the second device can be extended. Therefore, even if a distance between the first device and the second device is extended, the first device and the second device can communicate with each other correctly. This improves flexibility of arrangements of the first device and the second device.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a DVD player system of an embodiment according to the present invention;

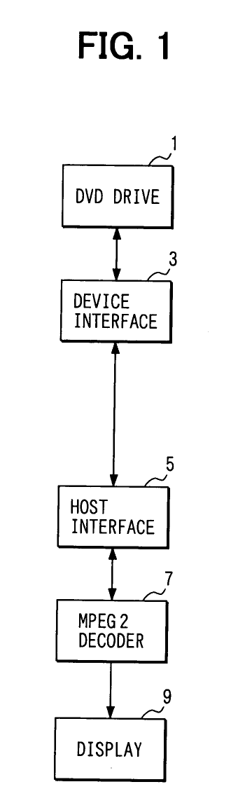

FIG. 2 is a block diagram showing a host interface of the embodiment;

FIG. 3 is a block diagram showing a device interface of the embodiment; and

FIG. 4 is a time chart of the DVD player system of the embodiment.

### DETAILED DESCRIPTION OF PREFERRED EMBODIMENTS

The preferred embodiments of the present invention will be explained with reference to the accompanying drawings.

A vehicular DVD player system includes a DVD drive 1, a device interface 3, a host interface 5, a Motion Picture Experts Group-2 (MPEG2) decoder 7, and a display 9. The DVD drive 1 has an ATAPI interface, and corresponds to a device of the present invention. The device interface 3 is an interface that performs protocol conversion, and has an ATAPI interface and a high speed LAN interface. The ATAPI interface of the device interface 3 is connected to the ATAPI interface of the DVD drive 1, and the high speed LAN interface is connected to the host interface 5.

The host interface 5 performs protocol conversion, and has an ATAPI interface and a high speed LAN interface. The ATAPI interface of the host interface 5 is connected to the MPEG2 decoder 7, and the high speed LAN interface is connected to the device interface 3.

The MPEG2 decoder 7 decodes MPEG2 data, and converts them to image signals so that the display 7 shows the image signals. It has an ATAPI interface and an output interface for the image signals. The ATAPI interface of the MPEG2 decoder 7 is connected to the ATAPI interface of the host interface 5, and communicates with the host interface 5. The output interface provides the image signals to the display 7.

The display 7 has an input interface for the image signals. It receives the image signals from the MPEG2 decoder 7 via the input interface, and shows images that correspond to the image signals. The display 7 is constructed of a liquid crystal display (LCD) or a cathode ray tube (CRT).

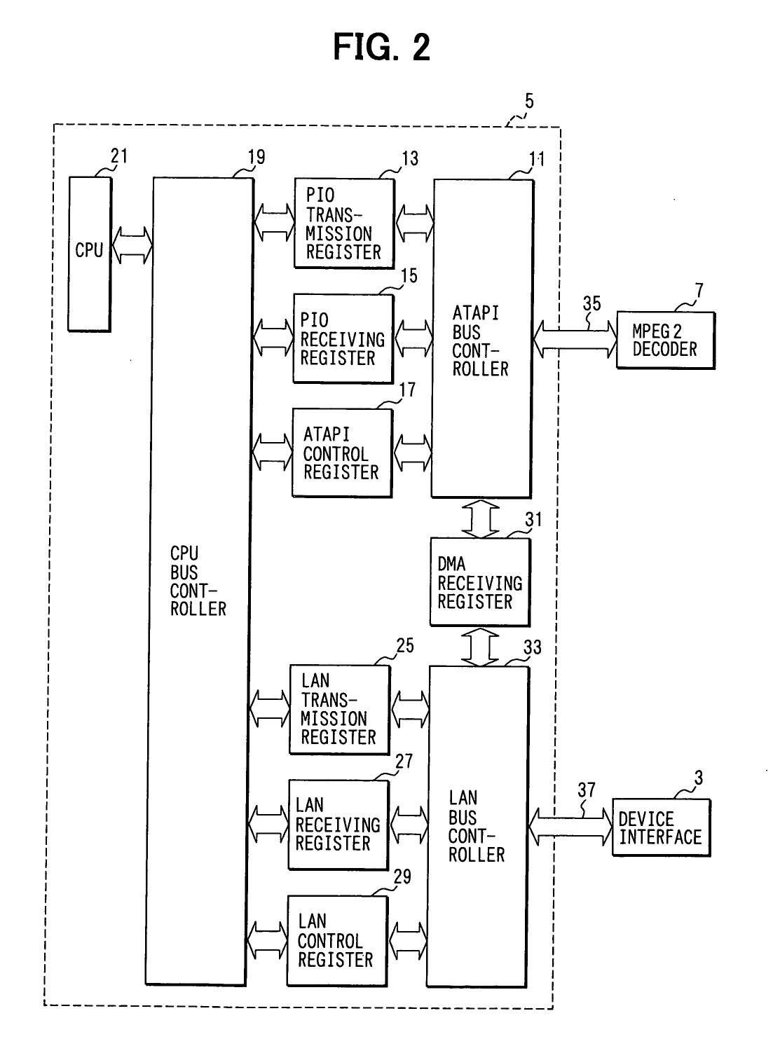

As shown in FIG. 2, the host interface 5 includes an ATAPI bus controller 11, a programmed input-output (PIO) transmission register 13, a PIO receiving register 15, an ATAPI control register 17, a CPU bus controller 19, and a CPU 21. It also includes a LAN transmission register 25, a LAN receiving register 27, a LAN control register 29, a direct memory access (DMA) receiving register 31, and a LAN bus controller 33.

The ATAPI bus controller 11 communicates with the PIO transmission register 13, the PIO receiving register 15, the ATAPI control register 17, and the DMA receiving register 31. It is connected to the MPEG2 decoder 7 via an ATAPI cable 35, and controls communication on the ATAPI cable 35.

The PIO transmission register 13 is provided between the ATAPI bus controller 11 and the CPU bus controller 19. It has a status register that stores a status data, and a data register that stores data. The PIO transmission register has a First-In First-Out (FIFO) structure. The PIO transmission register 13 corresponds to a memory of the present invention.

The PIO receiving register 15 is provided between the ATAPI bus controller 11 and the CPU bus controller 19. It has a command register that stores a command, and a data register that stores data. The PIO receiving register 15 has a FIFO structure.

The ATAPI control register 17 is provided between the ATAPI bus controller 11 and the CPU bus controller 19. It is a register that controls ATAPI communication.

The CPU bus controller 19 controls communication among the PIO transmission register 13, the PIO receiving register 15, the ATAPI control register 17, the CPU 21, the LAN transmission register 25, the LAN receiving register 27, and the LAN control register 29.

The CPU 21 can convert an ATAPI protocol and a high speed LAN protocol each other on real time. It controls every part of the host interface 5 based on programs.

The LAN transmission register 25 is provided between the CPU bus controller 19 and the LAN bus controller 33. When the LAN transmission register 25 receives data from the CPU bus controller 19, it stores the data temporarily. Then, it transmits the stored data to the LAN bus controller 33 when it receives a command from the LAN bus controller 33.

The LAN receiving register 27 is provided between the CPU bus controller 19 and the LAN bus controller 33. When the LAN receiving register 27 receives data from the LAN bus controller 33, it stores the data temporarily. Then, it transmits the stored data to the CPU bus controller 19 when it receives a command from the CPU bus controller 19.

The LAN control register 29 is provided between the CPU bus controller 19 and the LAN bus controller 33. It is a register that controls high speed LAN communication.

The LAN bus controller 33 communicates with the LAN transmission register 25, the LAN receiving register 27, the LAN control register 29, and the DMA receiving register 31. It is connected to the device interface 3 via a LAN cable 37, and controls communication on the LAN cable 37.

The DMA receiving register 31 is a register that is used for transferring data, which is called DMA transfer, from the LAN bus controller 33 to the ATAPI bus controller 11 without the CPU 21. The DMA receiving register 31 has a FIFO structure.

A controller for the host interface of the present invention includes the PIO transmission register 13, the PIO receiving register 15, the ATAPI control register 17, the CPU bus controller 19, the CPU 21, the LAN transmission register 25, the LAN receiving register 27, and the LAN control register 29.

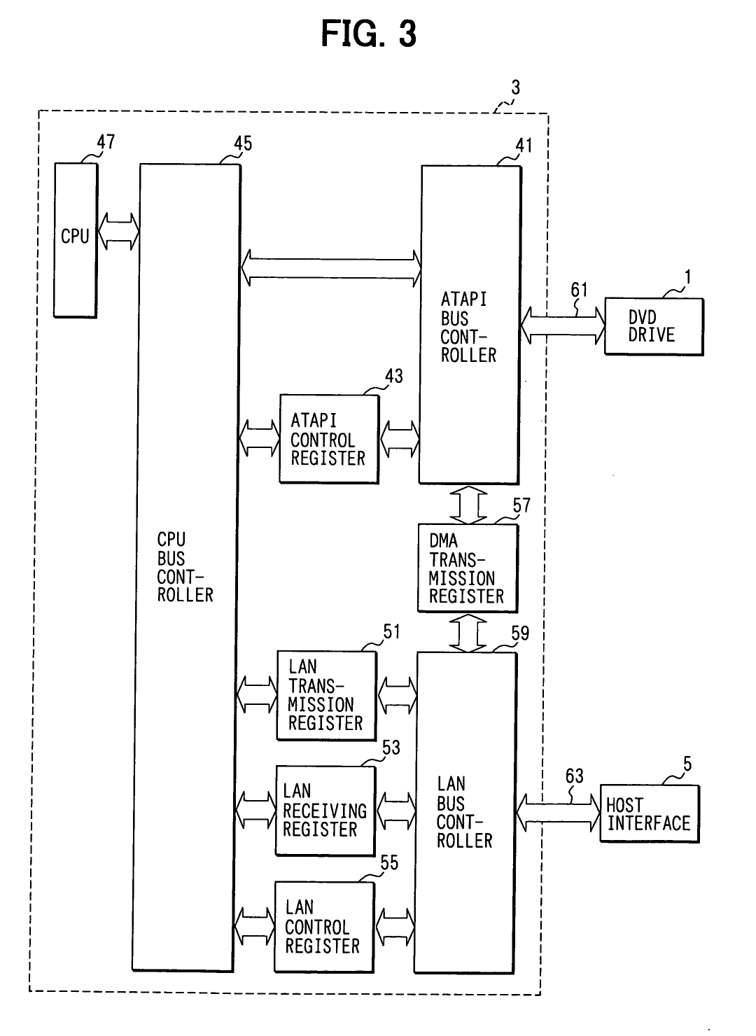

As shown in FIG. 3, the device interface 3 has a similar structure as the host interface 7. The device interface 3 includes an ATAPI bus controller 41, an ATAPI control register 43, a CPU bus controller 45, a CPU 47, a LAN transmission register 51, a LAN receiving register 53, a LAN control register 55, a DMA transmission register 57, and a LAN bus controller 59.

The ATAPI bus controller 41 communicates with the ATAPI control register 43, the CPU bus controller 45, and the DMA transmission register 57. It is connected to the DVD drive 1 via an ATAPI cable 61, and controls communication on the ATAPI cable 61.

The ATAPI control register 43 is provided between the ATAPI bus controller 41 and the CPU bus controller 45. It is a register for controlling an ATAPI communication.

The CPU bus controller 45 controls communication among the ATAPI control register 43, the CPU 47, the LAN transmission register 51, the LAN receiving register 53, and the LAN control register 55.

The CPU 47, the LAN transmission register 51, the LAN receiving register 53, the LAN control register 55, and the LAN bus controller 59 are identical with the CPU 21, the LAN transmission register 25, the LAN receiving register 27, the LAN control register 29, and the LAN bus controller 33 of the host interface 5 shown in FIG. 2, respectively.

The DMA transmission register 57 is a register that is used for transferring data from the ATAPI bus controller 41 to the LAN bus controller 59 without the CPU 47. The DMA transmission register 57 has a FIFO structure.

A controller for the device interface of the present invention includes the ATAPI control register 43, the CPU bus controller 45, the CPU 47, the LAN transmission register 51, the LAN receiving register 53, and the LAN control register 55.

The host interface 5 operates as follows. The DVD player system is operated with commands from the MPEG2 decoder 7, which is a host device.

(1) Receiving Process of ATAPI Commands

When the ATAPI bus controller 11 receives first register data from the MPEG2 decoder 7, it controls the PIO receiving register 15 so that the PIO receiving register 15 stores the register data temporarily. The first register data includes various kinds of data, such as a device control, a feature, a sector count, a sector number, a byte count least significant bit (LSB), a byte count most significant bit (MSB), a device/head, a command. When the PIO receiving register 15 completes storing the register data, the ATAPI bus controller 11 transmits data related to the completion of the storing after turning on an interrupt flag of the ATAPI control register 17. It also transmits indicative data, which indicates that the CPU 21 is in an active state, to the MPEG2 decoder 7 after turning on a busy flag (access prohibition flag) of the ATAPI bus controller 11.

When the CPU 21 receives the indicative data, it reads a command and a status data from the PIO receiving register 15 via the CPU bus controller 19. Then, it performs a process in accordance with the command. For example, it converts the command to a high speed LAN command, and transmits a LAN command and a LAN packet data.

(2) Receiving Process of ATAPI Packet Data

When the ATAPI bus controller 11 receives ATAPI packet data from the MPEG2 decoder 7, it controls the PIO receiving register 15 so that the PIO receiving register 15 stores the ATAPI packet data temporarily. When the ATAPI bus controller 11 completes receiving the ATAPI packet data corresponding to 6 words, it transmits complete data related to the completion of the receiving after turning on the interrupt flag of the ATAPI control register 17. It also transmits indicative data, which indicates that the CPU 21 is in the active state, to the MPEG2 decoder 7 after turning on the busy flag of the ATAPI bus controller 11.

When the CPU 21 receives the indicative data, it reads the packet data from the PIO receiving register 15 via the CPU bus controller 19. Then, the interrupt flag and the busy flag of the ATAPI bus controller 11 is turned off by the CPU 21 when the CPU 21 receives all packet data from the PIO receiving register 15. The storing operation of the packet data from the ATAPI bus controller 11 to the PIO receiving register 15 and the reading operation of the packet data from the PIO receiving register 15 to the CPU 21 via the CPU bus controller 19 can be performed simultaneously because the PIO receiving register 15 has the FIFO structure. The CPU 21 analyzes the packet data, and converts the packet data to high speed LAN packet data, so that it transmits the LAN command and the LAN packet data.

(3) Transmitting Process of ATAPI Status Data

When the host interface 5 receives a second register data of the DVD drive 1 via the device interface 3, it stores the register data in the PIO transmission register 13. The second register data includes various kinds of data, such as an Alt.Status, an error, an interrupt reason, a section number, a byte count LSB, a byte count MSB, a device/head, a status. When the MPEG2 decoder 7 inquires the second register data of the DVD drive 1 from the host interface 5, the host interface 5 transmits the second register data from the PIO transmission register 13 to the MPEG2 decoder 7 via the ATAPI bus controller 11 and the ATAPI cable 35.

(4) Transmitting Process of ATAPI Packet Data

The CPU 21 controls the PIO transmission register 13 via the CPU bus controller 19 to store the packet data in the PIO transmission register 13. Then, the CPU 21 turns off the busy flag of the ATAPI control register 17 via the CPU bus controller 19, and sets a data request (DRQ) flag being turned on.

Then, the ATAPI bus controller 11 reads the packet data from the PIO transmission register 13, and transmits the packet data to the MPEG2 decoder 7. When the ATAPI bus controller 11 completes transmitting all packet data, it turns on the busy flag, and turns off the DRQ flag.

(5) Transmitting Process of ATAPI Streaming Data

When the LAN bus controller 33 receives streaming data, it transmits the streaming data to the DMA receiving register 31. The DMA receiving register 31 stores the streaming data temporarily. The CPU 21 sets a DMA permissible flag of the ATAPI control register 17. It also transmits a DMA request (DMARQ) signal, which is a request signal for starting a DMA transmission, to the MPEG2 decoder 7 via the ATAPI bus controller 11. Then, the ATAPI bus controller 11 reads the streaming data from the DMA receiving register 31, and transmits them to the MPEG2 decoder 7. When the ATAPI bus controller 11 reads all streaming data, the ATAPI bus controller 11 cancels the DMARQ signal and halts to transmit the streaming data.

(6) Transmitting Process of LAN Commands and LAN Packet Data

The CPU 21 stores transmission commands and transmission packet data in the LAN transmission register 25 via the CPU bus controller 19. Then, the LAN bus controller 33 transmits the commands and the packet data at certain timings according to a protocol of the high speed LAN. When the LAN bus controller 33 completes transmitting the commands and the packet data, it sets a completion flag in the LAN control register 29, and indicates the completion to the CPU 21 via the CPU bus controller 19.

(7) Receiving Process of LAN Commands and LAN Packet Data

When the LAN bus controller 33 receives commands and packet data, it sets an interrupt flag of the LAN control register 29. The LAN receiving register 27 stores the commands and the packet data. When the CPU 21 confirms the interrupt flag of the LAN control register 29 via the CPU bus controller 19, it reads the commands and the packet data from the LAN receiving register 27 via the LAN bus controller 19.

(8) Receiving Process of LAN Streaming Data

When the LAN bus controller 33 receives streaming data that corresponds to a unit byte according to a protocol of the streaming data, it forwards the streaming data to the DMA receiving register 31. It also indicates the forwarding of the streaming data to the CPU 21 via the LAN control register 29 and the CPU bus controller 19. Then, the CPU 21 controls the ATAPI bus controller 11 to read the streaming data from the DMA receiving register 31, and to transmit them to the MPEG2 decoder 7 based on the transmission process of the ATAPI streaming data.

The device interface 3 operates as follows.

(1) Transmitting Process of ATAPI Commands and ATAPI Packet Data

ATAPI commands and ATAPI packet data are promptly sent from the CPU 47 to the DVD drive 1 via the CPU bus controller 45 and the ATAPI bus controller 41 without the ATAPI control register 43. The ATAPI control register 43 is used for confirming a status of ATAPI communication.

(2) Receiving Process of ATAPI Status Data and ATAPI Packet Data

When the ATAPI bus controller 41 receives ATAPI status data (register data) and ATAPI packet data from the DVD drive 1, it transmits the ATAPI status data and the ATAPI packet data to the CPU 47 via the ATAPI bus controller 41 and the CPU bus controller 45. The CPU 47 promptly receives the ATAPI status data and the ATAPI packet data from the ATAPI bus controller 41 without the ATAPI control register 43.

(3) Receiving Process of ATAPI Streaming Data

When the ATAPI bus controller 41 detects a DMARQ signal from the DVD drive 1 in condition that the CPU 47 sets a DMA permissible flag of the ATAPI control register 43 via the CPU bus controller 45, the ATAPI bus controller 41 starts to receive the ATAPI streaming data. When the ATAPI bus controller 41 receives the ATAPI streaming data, it transmits the ATAPI streaming data to the DMA transmission register 57. The DMA transmission register 57 stores the ATAPI streaming data temporarily. When the ATAPI bus controller 41 completes receiving the ATAPI streaming data, it sets a completion flag of the ATAPI streaming data in the ATAPI control register 43, and indicates the completion to the CPU 47.

(4) Transmitting and Receiving Process of LAN Commands and LAN Packet Data

Transmitting and receiving process of LAN commands and LAN packet data in the device interface 3 are the same processes of the host interface 5. Correspondent bus controllers 45, 49 and the registers 51, 53, 55 function similar to the bus controllers 19, 33 and the registers 25, 27, 29, respectively.

(5) Transmitting Process of LAN Streaming Data

The CPU 47 sets a transmission start flag for LAN streaming data of the LAN control register 55 via the CPU bus controller 45. Then, the LAN bus controller 59 reads the LAN streaming data stored in the DMA transmission register 57, and it transmits the LAN streaming data to the host interface 5 via a LAN cable 63 at certain timings according to a protocol of the high speed LAN. When the LAN bus controller 59 completes transmitting the LAN streaming data, it sets a transmission completion flag for the LAN streaming data of the LAN control register 55, and indicates the completion to the CPU 47.

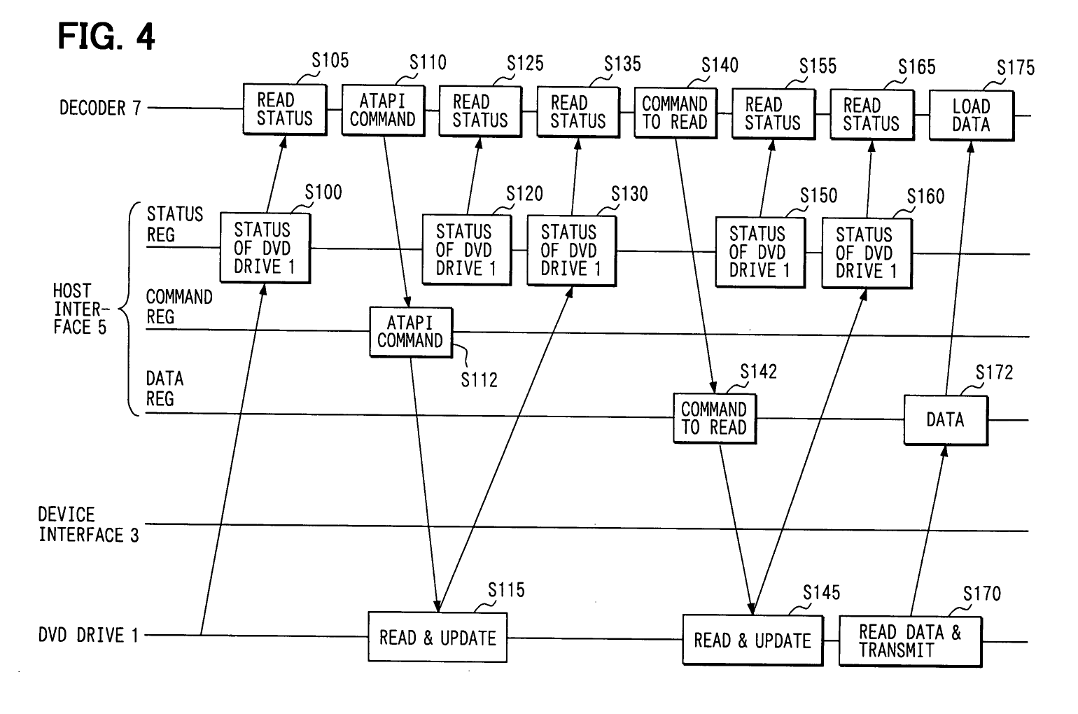

FIG. 4 is a timing diagram that shows whole processes when the MPEG2 decoder 7 executes a read command.

The status register in the PIO transmission register 13 of the host interface 5 stores a status data of the DVD drive 1 (S100). The MPEG2 decoder 7 reads the status data, which is previously stored in the host interface 5 (Sl05). The previously stored status data is the second register data, which is stored in the status register in the PIO transmission register of the host interface 5.

The MPEG2 decoder 7 issues an ATAPI command to the DVD drive 1 after confirming that the status of the DVD drive 1 is in a condition to execute the ATAPI command (S110). The ATAPI command expresses that the next packet data is a command.

The host interface 5 temporarily stores the ATAPI command in the command register of the PIO receiving register 15, and transmits the ATAPI command to the DVD drive 1 at certain timing (S112).

When the DVD drive 1 receives the ATAPI command, it interprets the ATAPI command. Then, it changes the status data of a status flag. It also transmits a completion data, which expresses a completion of changing the status data, to the MPEG2 decoder 7 (S115).

However, it takes at least 400 nanoseconds, which is defined by the ATAPI standard, by the time the completion data arrives in the MPEG2 decoder 7 after the MPEG2 decoder 7 issues the ATAPI command. As a result, in such a situation, an error occurs in the DVD player system.

Therefore, the host interface 5 transmits provisional status data, which is determined based on the previous status data stored in the host interface 5, to the MPEG2 decoder 7 in order to solve the situation (S120). The MPEG2 decoder 7 receives and reads the provisional status data (S125). The processes S120, S125 for transmitting and receiving the provisional status data are repeated at a certain time period. The processes S120, S125 are repeated by the time that the completion data arrives in the host interface 5, the status data in the host interface 5 is updated (S130), and then the MPEG2 decoder 7 reads the updated status data (S135). FIG. 4 shows one of the repeating processes S120, S125.

The MPEG2 decoder 7 issues a READ command, which is included in packet data, after confirming the completion of changing the status data (S140). The host interface 5 temporarily stores the packet data in the data register, and transmits the packet data to the DVD drive 1 via the device interface 3 at certain timing (S142).

When the DVD drive 1 receives the packet data that includes the READ command, it interprets the command. Then, it prepares a data transmission. When the preparation of the data transmission is completed, the DVD drive 1 also updates the status data in the status flag to express the completion of the preparation, and transmits the status data to the MPEG2 decoder 7 (S145).

However, it takes at least 400 nanoseconds, which is defined by the ATAPI standard, by the time the updated status data arrives in the MPEG2 decoder 7 after the MPEG2 decoder 7 issues the READ command. Therefore, the MPEG2 decoder 7 receives provisional status data from the host interface 5 in the same manner as the steps S120 to S135. When the MPEG2 decoder 7 receives the updated status data, it proceeds to next step S175 (S150-S165).

After the DVD drive 1 transmits the updated status data to the MPEG2 decoder 7, it also starts to read data in the DVD disk and to transmit the data to the host interface 5 via the device interface 3 (S170). When the host interface 5 receives the data, it temporarily stores the data in the data register. The host interface 5 also transmits the data to the MPEG2 decoder 7 at certain timing (Sl72). The MPEG2 decoder 7 receives and loads the data (S175).

Then, the DVD drive 1 transmits completion data, which expresses a completion of the transmission, to the MPEG2 decoder 7 after it completes to transmit all data. It also initializes the status flag, and changes a state in an idle state.

According to the host interface 5 and the device interface 3, the DVD player system has following advantages.

The host interface 5 and the device interface 3 communicate with each other by the high speed LAN data, which is converted from the ATAPI data in both interfaces 3 and 5. Accordingly, a connectable distance between the DVD drive 1 and the MPEG2 decoder 7 can be extend from 0.46 meter, which is defined by the ATAPI standard, to a long distance defined by the standard for the high speed LAN.

Since the host interface 5 has the PIO transmission register 13 as a structure that maintains the timings of the ATAPI standard, the DVD drive 1 and the MPEG2 decoder 7 can communicate with each other by the ATAPI communication without special structures and operations in them. This improves flexibility of arrangements of the DVD drive 1 and the MPEG2 decoder 7 through the use of the host interface 5 and the device interface 3.

The present invention should not be limited to the embodiments discussed above and shown in the figures, but may be implemented in various ways without departing from the spirit of the invention.

(1) Although the DVD drive 1 is used as the device in the embodiment, a HDD may be used as the device instead of the DVD drive 1. In such a situation, the device interface 3 and the host interface 5 have to have structures corresponding to communication of an ATA standard as well as the ATAPI standard. This has the same effect as the embodiment.

(2) Although the present invention is used for the DVD player system in the embodiment, it can be applied for communication between a DVD-ROM drive (CD-ROM drive) and a main unit of the vehicular navigation system. This improves flexibility of arrangements of the DVD-ROM drive (CD-ROM drive) and the main unit in the vehicle.

What is claimed is:

1. A host interface comprising:
a first interface that communicates first data defined by a first protocol with a first device;
a second interface that communicates second data defined by a second protocol with a second device; and
a controller that has a memory,
wherein the controller converts the first data to the second data defined by the second protocol when the first interface receives the first data from the first device, and transmits the second data to the second interface at a first certain timing,
the controller converts the second data to the first data defined by the first protocol when the second interface receives the second data from the second device, transmits the first data to the first interface at a second certain timing, and stores the first data in the memory, and
the controller transmits the first data stored in the memory to the first interface in response to a request from the first device unless the second interface receives subsequent second data from the second device.

2. A device interface comprising:
a first interface that communicates first data defined by a first protocol with a first device;
a second interface that communicates second data defined by a second protocol with a second device; and
a controller,
wherein the controller converts the first data to the second data defined by the second protocol when the first interface receives the first data from the first device, and transmits the second data to the second interface at a first certain timing, and
the controller converts the second data to the first data defined by the first protocol when the second interface receives the second data from the second device, and transmits the first data to the first interface at a second certain timing.

3. An interface system comprising:
a host interface having a first interface that communicates first data defined by a first protocol with a first device, a second interface that communicates second data defined by a second protocol, and a first controller that has a memory; and
a device interface having a third interface that communicates the first data defined by the first protocol with a second device, a fourth interface that communicates the second data defined by the second protocol, and a second controller,
wherein the second interface of the host interface is connected to the fourth interface of the device interface,
the first controller of the host interface converts the first data to the second data defined by the second protocol when the first interface of the host interface receives the first data from the first device, and transmits the second data to the second interface of the host interface at a first certain timing,
the second controller of the device interface converts the second data to the first data defined by the first protocol when the fourth interface of the device interface receives the second data from the second interface of the host interface, and transmits the first data to the third interface of the device interface at a second certain timing,
the second controller of the device interface converts the first data to the second data defined by the second protocol when the third interface of the device interface receives the first data from the second device, and transmits the second data to the fourth interface of the device interface at a third certain timing,
the first controller of the host interface converts the second data to the first data defined by the first protocol when the second interface of the host interface receives the second data from the fourth interface of the device interface, transmits the first data to the first interface of the host interface at a fourth certain timing, and stores the first data in the memory, and
the first controller of the host interface transmits the first data stored in the memory to the first interface in response to a request from the first device unless the second interface of the host interface receives subsequent second data from the fourth interface of the device interface.

4. A computer program product for controlling a host interface, which has a first interface that communicates first data defined by a first protocol with a first device, a second interface that communicates second data defined by a second protocol with a second device, and a memory, the computer program product comprising:
a first function for converting the first data to the second data defined by the second protocol when the first interface receives the first data from the first device, and transmitting the second data to the second interface at a first certain timing;
a second function for converting the second data to the first data defined by the first protocol when the second interface receives the second data from the second device, transmitting the first data to the first interface at a second certain timing, and storing the first data in the memory; and
a third function for transmitting the first data stored in the memory to the first interface in response to a request from the first device unless the second interface receives subsequent second data from the second device.

5. A computer program product for controlling a device interface, which has a first interface that communicates first data defined by a first protocol with a first device, and a second interface that communicates second data defined by a second protocol with a second device, the computer program product comprising:
a first function for converting the first data to the second data defined by the second protocol when the first interface receives the first data from the first device, and transmitting the second data to the second interface at a first certain timing; and
a second function for converting the second data to the first data defined by the first protocol when the second interface receives the second data from the second device, and transmitting the first data to the first interface at a second certain timing.

6. An interface system comprising:
a host interface that communicates first data defined by a first protocol with a first device; and
a device interface that communicates the first data defined by the first protocol with a second device,
wherein the host interface converts the first data to second data defined by a second protocol when the host interface receives the first data from the first device, and transmits the second data to the device interface,
the device interface converts the second data to the first data defined by the first protocol when the device interface receives the second data from the host interface, and transmits the first data to the second device,
the device interface converts the first data to the second data defined by the second protocol when the device interface receives the first data from the second device, and transmits the second data to the host interface, and
the host interface converts the second data to the first data defined by the first protocol when the host interface receives the second data from the device interface, and transmits the first data to the first device.

7. The host interface according to claim 1, wherein the first protocol is one of an ATA and an ATAPI, and the second protocol is different from the ATA and the ATAPI.

8. The host interface according to claim 1, wherein the first device is a host device, and the second device is different from the host device.

9. The interface system according to claim 6, wherein the host interface and the device interface are provided in a vehicle.
